(19) United States
(12) Patent Application Publication
(10) Pub. No.: US 2026/0071066 A1
(43) Pub. Date: Mar. 12, 2026

(54) PLAY COMPOUND COMPOSITION AND METHOD OF MANUFACTURE

(71) Applicant: Crayola LLC, Easton, PA (US)

(72) Inventors: Michael G. Moskal, Pottstown, PA (US); Olivia R. Chille, Altoona, PA (US); Michael L. Spera, Mohnton, PA (US)

(73) Assignee: Crayola LLC, Easton, PA (US)

(21) Appl. No.: 19/321,378

(22) Filed: Sep. 8, 2025

Related U.S. Application Data
(60) Provisional application No. 63/692,334, filed on Sep. 9, 2024.

(51) Int. Cl. C08L 29/04; C08K 3/34; C08K 3/36; C08K 3/38

(52) U.S. Cl. CPC C08L 29/04; C08K 3/34; C08K 3/36; C08K 3/38; C08K 2003/385

(57) ABSTRACT

A powder composition including at least a poly(vinyl alcohol) polymer, a crosslinker, calcium silicate, sodium starch glycolate, and a water-containing liquid, is described. A play compound including the powder composition and a second water-containing liquid is also described. A method of forming a play compound including the steps of forming a powder composition having a poly(vinyl alcohol) polymer, a crosslinker, calcium silicate, sodium starch glycolate, and a first water-containing liquid; and mixing the powder composition and a second water-containing liquid, is also described.

### CROSS-REFERENCES TO RELATED APPLICATIONS

The present application claims priority to U.S. Provisional Patent Application No. 63/692,334, filed on Sep. 9, 2024, the entire contents of which are incorporated by reference herein.

### FIELD OF THE INVENTION

Embodiments generally relate to a play compound composition, particularly to a powder composition that may be mixed with a water-containing liquid to form the play compound composition.

### BACKGROUND OF THE INVENTION

Standard commercial do-it-yourself (DIY) play compound kits, also described as slime kits, generally require mixing several ingredients in precise ratios. These kits include at least three separate ingredients, such as clear or white glue solutions and/or boron compound solutions (e.g., eye contact solution and baking soda or borax), and are often overly complicated and messy. For example, glue solutions are viscous liquids that are difficult to pour and measure accurately. Moreover, some traditional formulations rely on chemical crosslinkers that may be restricted or regulated in certain regions, such as boron compounds under EU REACH regulations, which can limit their use in commercial products.

As a result, there is a need for improved play compound compositions and methods that simplify the preparation process, reduce mess, and enhance safety and ease of handling

### SUMMARY OF THE INVENTION

The present disclosure relates to a play compound composition, specifically a powdered formulation that can be easily mixed with water to produce a moldable, slime-like material. The play compound composition aims to address the challenges associated with traditional DIY slime kits, which often involve a messy and cumbersome process. By providing a powder-based system, the invention facilitates a more convenient, less messy, and safer method for end-users to create play compounds.

In particular, embodiments generally relate to a specially formulated powder composition including key components such as a high-solubility poly(vinyl alcohol) polymer, a crosslinker, calcium silicate and/or silicon dioxide, sodium starch glycolate, and a small amount of a water-containing liquid. When combined with a second water-containing liquid and thoroughly mixed, this powder forms a play compound that exhibits desirable physical properties such as a slime-like, viscoelastic consistency, and the ability to be stretched, shaped, and manipulated easily. This approach simplifies measurement, handling, and mixing procedures, making it suitable for use by children and consumers without the need for precise liquid measurements or complex procedures.

In an exemplary embodiment, a powder composition includes a poly(vinyl alcohol) polymer; a crosslinker; calcium silicate and/or silicon dioxide; sodium starch glycolate; and a water-containing liquid.

In some embodiments, the poly(vinyl alcohol) polymer is dissolvable in room temperature water.

In some embodiments, the poly(vinyl alcohol) polymer has a weight average molecular weight of 85,000-124,000 g/mol.

In some embodiments the crosslinker includes a boron-containing crosslinker.

In some embodiments, the boron-containing crosslinker includes an aqueous ammonium pentaborate solution.

In some embodiments, the crosslinker includes a non-boron-containing crosslinker.

In some embodiments, the non-boron-containing crosslinker is selected from the group consisting of water-stable titanates and zirconates.

In some embodiments, the powder composition further includes hollow microspheres.

In some embodiments, the powder composition further includes at least one additive selected from the group consisting of fillers, colorants, preservatives, glitters, and fragrances.

In some embodiments, the powder composition further includes a filler, wherein the filler is cornstarch.

In some embodiments, the powder composition includes 30-75% by weight of the poly(vinyl alcohol) polymer; 0.1-5% by weight of the crosslinker; 0.1-5% by weight of the calcium silicate and/or the silicon dioxide; 3-10% by weight of the sodium starch glycolate; and 3-12% by weight of the water-containing liquid.

In an exemplary embodiment, a play compound includes the powder composition as described above; and a second water-containing liquid.

In some embodiments, a ratio of the powder composition to the second water-containing liquid is between 1:2 and 1:6.

In some embodiments, the play compounds has a viscosity of between 1000 and 8000 Pa-s.

In an exemplary embodiment, a kit for forming a play compound includes the powder composition described above.

In an exemplary embodiment, a method of forming a play compound includes forming a powder composition including a poly(vinyl alcohol) polymer, a crosslinker, calcium silicate and/or silicon dioxide, sodium starch glycolate, and a first water-containing liquid; and mixing the powder composition and a second water-containing liquid.

In some embodiments, mixing the powder composition and the second water-containing liquid includes shaking or stirring the powder composition and the second water-containing liquid.

In some embodiments, the method further includes kneading the mixture of the powder composition and the second water-containing liquid.

In some embodiments, the method further includes kneading the mixture of the powder composition and the second water-containing liquid to produce a slime consistency.

In some embodiments, forming a powder composition includes preparing a first composition by the mixing a poly(vinyl alcohol) polymer, the crosslinker, calcium silicate and/or silicon dioxide, and sodium starch glycolate; and adding the first-water containing liquid to the first composition to form the powder composition.

### DETAILED DESCRIPTION OF THE INVENTION

The following description is of exemplary embodiments and methods of use that are presently contemplated for carrying out the present invention. This description is not to be taken in a limiting sense but is made merely for the purpose of describing the general principles and features of various aspects of the present invention. The scope of the present invention is not limited by this description.

Unless defined otherwise, all technical and scientific terms used herein have the same meanings as commonly understood by one of ordinary skill in the art to which this invention belongs. Specific methods, devices, and materials are described, although any methods and materials similar or equivalent to those described herein can be used in the practice or testing of the present invention.

The present invention relates to powder compositions that can be formed into play compound compositions. As will be described in further detail, a powder composition may be added with a second water-containing liquid to form the play compound composition after mixing and kneading. A powder composition includes at least a poly(vinyl alcohol) polymer (PVOH), a crosslinker, calcium silicate and/or silicon dioxide, sodium starch glycolate, and a small amount of a first water-containing liquid. The powder compositions as described herein are preferably free-flowing powder compositions, such that the powder compositions are made up of particles that may flow easily and may not stick together.

The powder compositions include a PVOH. In one preferred embodiment, the PVOH is a high solubility PVOH. For example, the PVOH may dissolve readily in room temperature water (e.g., 20-25° C.). The PVOH may therefore be in powdered form and be of a small particle size grade, as large particle size grades and large macroscopic shapes such as pellets, granules, etc. typically require significant heating and high shear mixing to completely dissolve in water.

The weight average molecular weight (MW) of the PVOH is not particularly limited, though may range from 85,000 to 124,000 g/mol. As nonlimiting examples, the MW of the PVOH may be at least 85,000 g/mol, at least 95,000 g/mol, at least 105,000 g/mol, at least 115,000 g/mol, and/or the like. As further nonlimited examples, the MW of the PVOH may be no greater than 124,000 g/mol, no greater than 115,000 g/mol, no greater than 105,000 g/mol, no greater than 95,000 g/mol, and/or the like.

The MW of the PVOH may affect the stiffness of a play compound composition formed from the powder composition, such as when the play compound composition is stretched. For example, a higher MW PVOH may produce a stiffer play compound composition, while a lower MW PVOH may produce a more flexible play compound composition.

The PVOH may function as a polymeric binder, such that the PVOH may provide cohesion and stability to other components of a play compound composition. The PVOH can be present in the powder composition in any suitable amount. Preferably, the PVOH is present from about 30% to about 75% by weight of the powder composition, such as from about 40% to about 65% by weight.

As nonlimiting examples, the powder composition may include at least 30% by weight, at least 35% by weight, at least 40% by weight, at least 45% by weight, at least 50% by weight, at least 55% by weight, at least 60% by weight, at least 65% by weight, at least 70% by weight, and/or the like, of a PVOH. As further nonlimiting examples, the powder composition may include no greater than 75% by weight, no greater than 70% by weight, no greater than 65% by weight, no greater than 60% by weight, no greater than 55% by weight, no greater than 50% by weight, no greater than 45% by weight, no greater than 40% by weight, no greater than 35% by weight, and/or the like, of a PVOH.

The powder compositions further include a crosslinker. The crosslinker may include at least one boron-containing crosslinker, at least one non-boron-containing crosslinker, or mixtures thereof.

It is understood that certain compounds, such as boron compounds (e.g., boric acid and sodium tetraborate) typically used in traditional play compound compositions, may be restricted in the UK and/or EU as Substances of Very High Concern under the EU REACH Regulation. Accordingly, in embodiments including at least one boron-containing crosslinker, the crosslinker may include unrestricted compound(s) such as ammonium pentaborate tetrahydrate

The at least one non-boron-containing crosslinker may include water-stable titanates, zirconates, and mixtures thereof.

The crosslinker can be present in the powder compositions in any suitable amount. Preferably, the crosslinker is present from about 0.1% to about 5% by weight of the powder composition, such as from about 1.5% to about 3.5% by weight.

As nonlimiting examples, the powder composition may include at least 0.1% by weight, at least 0.5% by weight, at least 1% by weight, at least 2% by weight, at least 3% by weight, at least 4% by weight, and/or the like, of a crosslinker. As further nonlimiting examples, the powder composition may include no greater than 5% by weight, no greater than 4% by weight, no greater than 3% by weight, no greater than 2% by weight, no greater than 1% by weight, no greater than 0.5% by weight, and/or the like, of a crosslinker.

In some embodiments, the crosslinker may be added to the powder composition as an aqueous solution or dissolved in a water-miscible organic solvent. For example, the crosslinker may be provided as a 1% dilute solution, a 2% dilute solution, a 3% dilute solution, a 4% dilute solution, a 5% dilute solution, a 6% dilute solution, a 7% dilute solution, a 8% dilute solution, a 9% dilute solution, a 10% dilute solution, and/or the like.

In alternative embodiments, the crosslinker may be added to the powder composition as a (dry) solid composition.

The powder compositions further include at least one of calcium silicate and silicon dioxide (e.g., chemically prepared silicon dioxide). The calcium silicate and/or silicon dioxide may be configured as a flow aid such that it aids in maintaining a free-flowing state of the powder composition and/or aids in dispersing water throughout the powder composition, as described further below.

The calcium silicate and/or silicon dioxide can be present in the powder compositions in any suitable amount. Preferably, the calcium silicate is present from about 0.1% to about 5% by weight of the powder composition, such as from about 1.5% to about 3.5% by weight.

As nonlimiting examples, the powder composition may include at least 0.1% by weight, at least 0.5% by weight, at least 1% by weight, at least 2% by weight, at least 3% by weight, at least 4% by weight, and/or the like, of calcium silicate and/or silicon dioxide. As further nonlimiting examples, the powder composition may include no greater than 5% by weight, no greater than 4% by weight, no greater than 3% by weight, no greater than 2% by weight, no greater than 1% by weight, no greater than 0.5% by weight, and/or the like, of calcium silicate and/or silicon dioxide.

The powder compositions further include sodium starch glycolate. The sodium starch glycolate may be configured as a dissolution aid such that it prevents clumping of various components within the powder composition.

The sodium starch glycolate can be present in the powder compositions in any suitable amount. Preferably, the sodium starch glycolate is present from about 3% to about 10% by weight of the powder composition, such as from about 4.5% to about 8.2% by weight.

As nonlimiting examples, the powder composition may include at least 3% by weight, at least 4% by weight, at least 5% by weight, at least 6% by weight, at least 7% by weight, at least 8% by weight, at least 9% by weight, and/or the like, of sodium starch glycolate. As further nonlimiting examples, the powder composition may include no greater than 10% by weight, no greater than 9% by weight, no greater than 8% by weight, no greater than 7% by weight, no greater than 6% by weight, no greater than 5% by weight, no greater than 4% by weight, and/or the like, of sodium starch glycolate.

The powder compositions include a first water-containing liquid. The first water-containing liquid may include or consist of water. The first water-containing liquid may be configured to help disperse various components in the powder composition, such as the sodium starch glycolate, the crosslinker, etc. Put differently, the purpose of the first water-containing liquid is not to solubilize components of the powder composition.

The first water-containing liquid can be present in the powder compositions in any suitable amount. Preferably, the first water-containing liquid is present in a small amount, such as from about 3% to about 12% by weight of the powder composition, such as from about 5% to about 10% by weight.

As nonlimiting examples, the powder composition may include at least 3% by weight, at least 4% by weight, at least 5% by weight, at least 6% by weight, at least 7% by weight, at least 8% by weight, at least 9% by weight, at least 10% by weight, at least 11% by weight, and/or the like, of a first water-containing liquid. As further nonlimiting examples, the powder composition may include no greater than 12% by weight, no greater than 11% by weight, no greater than 10% by weight, no greater than 9% by weight, no greater than 8% by weight, no greater than 7% by weight, no greater than 6% by weight, no greater than 5% by weight, no greater than 4% by weight, and/or the like, of a first water-containing liquid.

The powder compositions can optionally include at least one additive, such as fillers, colorants, pH adjusters, preservatives, and special effect components.

Fillers may be used to modify the texture of the resulting play compound composition, such as to smoothen the play compound composition. Fillers may additionally, or alternatively, be used to add opacity to resulting play compound composition. In exemplary embodiments, corn starch may be used as a filler to modify the texture of the play compound composition and/or add opacity to the play compound composition.

Fillers can be present in the powder compositions in any suitable amount. Preferably, fillers may be present in certain embodiments from about 0.1% to about 40% by weight of the powder composition, such as from about 25% to about 35% by weight.

As nonlimiting examples, the powder composition may include at least 0.1% by weight, at least 0.5% by weight, at least 1% by weight, at least 5% by weight, at least 10% by weight, at least 15% by weight, at least 20% by weight, at least 25% by weight, at least 30% by weight, at least 35% by weight, and/or the like, of at least one filler. As further nonlimiting examples, the powder composition may include no greater than 40% by weight, no greater than 35% by weight, no greater than 30% by weight, no greater than 25% by weight, no greater than 20% by weight, no greater than 15% by weight, no greater than 10% by weight, no greater than 5% by weight, no greater than 1% by weight, and/or the like, of at least one filler.

Colorants may include at least one dye, at least one pigment, and mixtures thereof. In some embodiments, more than one colorant may be combined in various amounts to provide for colors (e.g., brown) that may not be available in dye or pigment form.

pH adjusters may be used to modify the acidity or alkalinity (e.g., pH level) of the powder composition and resulting play compound composition. pH adjusters may ensure that the pH of the powder composition and resulting play compound composition is within a desired range for optimal performance, stability, and safety.

pH adjusters can be present in the powder compositions in any suitable amount. Preferably, pH adjusters may be present in certain embodiments from about 2% to about 15% by weight of the powder composition, such as from about 5% to about 12% by weight.

As nonlimiting examples, the powder composition may include at least 2% by weight, at least 4% by weight, at least 6% by weight, at least 8% by weight, at least 10% by weight, at least 12% by weight, and/or the like, of at least one pH adjuster. As further nonlimiting examples, the powder composition may include no greater than 15% by weight, no greater than 12% by weight, no greater than 10% by weight, no greater than 8% by weight, no greater than 6% by weight, no greater than 4% by weight, and/or the like, of at least one pH adjuster.

Preservatives may be configured to inhibit microbial growth in products that contain water or may become wet. Accordingly, preservatives may be used in the powder compositions such that the resulting play compound compositions may be stored for reuse for extended periods of time.

Preservatives can be present in the powder compositions in any suitable amount. Preferably, Preservatives may be present in certain embodiments from about 1% to about 10% by weight of the powder composition, such as from about 2.5% to about 7.5% by weight.

As nonlimiting examples, the powder composition may include at least 1% by weight, at least 2% by weight, at least 3% by weight, at least 4% by weight, at least 5% by weight, at least 6% by weight, at least 7% by weight, at least 8% by weight, at least 9% by weight, and/or the like, of at least one preservative. As further nonlimiting examples, the powder composition may include no greater than 10% by weight, no greater than 9% by weight, no greater than 8% by weight, no greater than 7% by weight, no greater than 6% by weight, no greater than 5% by weight, no greater than 4% by weight, no greater than 3% by weight, no greater than 2% by weight, and/or the like, of at least one preservative.

Special effect components may be configured to enhance the visual or odor effects of the moldable compositions. Exemplary special effect components include, but are not limited to, glitters, metallic effect particles, fragrances, etc.

The powder compositions can optionally at least one density reducing fillers. The density reducing fillers may provide a light, fluffy play compound composition. In one embodiment, the density reducing fillers may include hollow microspheres. In one embodiment, the density reducing fillers include materials containing microscopic air-filled voids, such as expanded cellular minerals.

In preferred embodiments, the powder composition does not include one or more of clear or white glue (e.g., polyvinyl acetate), borax (e.g., sodium tetraborate), boron containing eye contact solution, and/or the like.

The present invention also relates to methods of forming powder compositions and play compound compositions described herein. In certain embodiments, methods may include combining the above-listed components to form a powder composition. In certain embodiments, the order of addition of the components may not be particularly limited. In preferrable embodiments, the first water-containing liquid is added last (e.g., as a final component).

In some embodiments, a first premix composition may be formed by combining a PVOH polymer, calcium silicate and/or silicon dioxide, sodium starch glycolate, and optionally one or more filler. Separately, a second premix composition may be provided in the form of an aqueous solution including the crosslinker. The first premix composition and the second premix composition may then be combined (with or without the first water-containing liquid).

Any suitable combining and/or mixing apparatus(es) may be used to combine and mix the above-mentioned components in forming the powder composition. For example, a high shear mechanical mixer, such as a kitchen blender or a grinder, may be used to combine and mix the above-mentioned components in forming the powder composition.

A second water-containing liquid may be combined with the powder composition. The second water-containing liquid may include or consist of water. The second water-containing liquid may the same as or different than the first water-containing liquid of the powder composition.

The resulting combination may then be mixed (e.g., with a spatula, shaken or stirred vigorously, etc.) to adequately combine the second water-containing liquid and the powder composition into a homogenous or substantially homogenous resulting mixture. For example, the second water-containing liquid and the powder composition may be added to a sealable container and shaken or stirred vigorously for a sufficient period of time (e.g., sixty seconds) to adequately combine the second water-containing liquid and the powder composition. Once mixed, the resulting mixture may be kneaded (e.g., worked) to even the consistence of the resulting mixture and form the play compound composition. Kneading the play compound composition may provide the composition with texture, elasticity, etc.

The second water-containing liquid and the powder composition may be combined at any ratio. In an exemplary embodiment, the ratio of powder composition to the second water-containing liquid may be between 1:2.0 and 1:6.0. Flexibility and softness of the play compound composition may be varied by adjusting the ratio of the powder composition to the second water-containing liquid.

As nonlimiting examples, the ratio of powder composition to the second water-containing liquid may be at least 1:2.0, at least 1:2.5, at least 1:3.0, at least 1:3.5, at least 1:4.0, at least 1:4.5, at least 1:5.0, at least 1:5.5 and/or the like. As further nonlimiting examples, the powder composition may include no greater than 1:6.0, no greater than 1:5.5, no greater than 1:5.0, no greater than 1:4.5, no greater than 1:4.0, no greater than 1:3.5, no greater than 1:3.0, no greater than 1:2.5, and/or the like.

The present invention also relates to play compound compositions formed from the powder compositions. In particular, the powder composition may be added with a second water-containing liquid to form the play compound composition after mixing and kneading. The second water-containing liquid may the same as or different than the first water-containing liquid of the powder composition.

The play compound composition may have a viscosity between 1000 and 8000 Pa-s (e.g., between 1,000,000 and 8,000,000 cP), as measured using a TA Instruments Discovery HR-2 hybrid rheometer with a 20 mm parallel plate (upper geometry) and Peltier plate (lower geometry) at 25° C. The play compound composition may have a viscosity that allows it flow and be manipulated easily. Alternatively or additionally, the play compound composition may have a viscosity such that it may hold its form when manipulated to a desired shape.

The play compound may have a slime-like consistency. For example, the play compound composition may be viscoelastic material that exhibits both liquid-like and solid-like properties. The play compound composition may be elastic such that it can stretch and return to its original shape and may be stretched without breaking.

In certain embodiments, the play compound composition may exhibit dilatant properties. In particular, the play compound composition may exhibit an increase in viscosity when subjected to shear stress or deformation. For example, the play compound may stretch when pulled slowly, but may snap (e.g., break apart) when pulled sharply. Additionally, the play compound may bounce if dropped onto a hard surface.

The play compound composition may have a slightly tacky or sticky surface, which may enhance the tactile experience.

The play compound composition may have an initial color, which may be determined by the color of the components of the powder composition, such as the color of optional colorants added to the powder composition or the intrinsic colors of other components.

In certain embodiments, the color of the play compound composition may be modified during its formation, such as before or during mixing of the powder composition with the second water-containing liquid, or after its formation. In some embodiments, at least one colorant may be added to the play compound composition after its formation. Colorants may include at least one dye (e.g., dye drop), at least one pigment, and mixtures thereof. Additionally or alternatively, the play compound composition may be colored with markers and/or watercolor paints and/or drip ink. Additionally or alternatively, the play compound may be colored with dissolvable films, such as those described in U.S. Pat. No. 9,822,257, the contents of which are incorporated by reference herein.

The texture of play compound compositions may be smooth. In certain embodiments, small objects (e.g., colored beads, glitter, etc.) may be added to the play compound composition after its formation to change its texture and/or appearance. Such objects may also provide different sensory experiences during use.

The present invention also relates to a kit including the powder composition as disclosed hereinabove. In certain embodiments, a kit may also be provided with a container, such as a sealable container. In such embodiments, a user may add the powder composition and a second water-containing liquid to the container, and mix the powder composition and second water-containing (e.g., by shaking the container vigorously) to form the play compound composition. The powder composition may therefore be considered a ready-made powder that is readily mixable with a water-containing liquid to form the play compound composition.

A kit may also include at least one colorant, marker, watercolor paint, drip ink, dissolvable film, etc., to modify the color of the play compound composition during or before its formation. A kit may also include small objects (e.g., colored beads, glitter, etc.) to add to the play compound composition during or before its formation.

### EXAMPLES

Example 1: Exemplary powder compositions according to the disclosure provided herein were prepared.

TABLE 1

| | Inventive | Inventive |
|---|---|---|
| | Example A | Example B |
| Component | wt % | wt % |
| Selvol 523S PVOH | 42.50 | 61.59 |
| Cornstarch (Filler) | 31.00 | — |
| Calcium Silicate | 2.00 | 2.90 |
| Sodium Bicarbonate (pH adjuster) | 7.00 | 10.14 |
| Sodium Starch Glycolate | 5.50 | 7.97 |
| Potassium Sorbate (Preservative) | 3.00 | 4.35 |
| Sodium Benzoate (Preservative) | 1.00 | 1.45 |
| 5% Ammonium Pentaborate | 2.00 | 2.90 |
| Tetrahydrate (crosslinker) | | |
| Water | 6.00 | 8.70 |
| | 100.00 | 100.00 |

Inventive Example A and/or Inventive Example B may be combined with a water-containing liquid, mixed, and kneaded to form inventive plat compound composition(s).

Example 2: Exemplary powder compositions, particularly example first premix and second premix compositions, according to the disclosure provided herein were prepared.

TABLE 2
First Premix Composition

| | Inventive | Inventive | Inventive | Inventive |
|---|---|---|---|---|
| | Example A | Example B | Example C | Example D |
| Component | wt % | wt % | wt % | wt % |
| Selvol 523S PVOH Powder | 46.96 | 46.96 | 46.20 | 69.67 |
| Cornstarch (Filler) | 33.60 | 33.60 | 33.70 | — |
| Zeofree 600 (Calcium Silicate) | 2.18 | — | 2.17 | 3.28 |
| Sipernat 37 or Sipernat | — | 2.18 | — | — |
| 50S (Silicon Dioxide) | | | | |
| Sodium Bicarbonate (pH adjuster) | 7.65 | 7.65 | 7.61 | 11.47 |
| Sodium Starch Glycolate | 6.01 | 6.01 | 5.98 | 9.02 |
| Potassium Sorbate (Preservative) | 3.28 | 3.28 | 3.26 | 4.92 |
| Sodium Benzoate (Preservative) | 0.33 | 0.33 | 1.09 | 1.64 |
| | 100.00 | 100.00 | 100.00 | 100.00 |

TABLE 3
Second Premix Composition

| Component | wt % |
|---|---|
| Water | 93.60 |
| Ammonium Pentaborate Tetrahydrate (crosslinker) | 1.18 |
| Preventol CMK40 (preservative) | 2.37 |
| PW40 (preservative) | 2.84 |
| | 100.00 |

The first premix composition and the second premix composition may be combined with one another (and optionally with a first water containing liquid) to form a powder composition. The powder composition may then be combined with a second water-containing liquid, mixed, and kneaded to form inventive plat compound composition(s).

Example 3: Exemplary play compound compositions according to the disclosure provided herein were prepared.

TABLE 2

| | Powder | Water- | |
|---|---|---|---|
| Example | Compo- | Containing | |
| No. | sition | Liquid | Outcome |
| 1 | 10.0 g | 30.0 g | less-“sticky” slime-like consistency |
| | | | not a compound, but not a complete |
| | | | liquid composition |
| 2 | 10.0 g | 37.5 g | slime-like consistency |
| | | | able to hand manipulate |
| | | | sticky, but simple to play with and |
| | | | control |
| 3 | 10.0 g | 15.0 g | compound-like consistency |
| | | | less malleable |
| | | | no stickiness |
| 4 | 5.0 g | 30.0 g | very sticky slime-like consistency |
| | | | more of a liquid consistency |

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A powder composition, comprising:
a poly(vinyl alcohol) polymer;
a crosslinker;
calcium silicate and/or silicon dioxide;
sodium starch glycolate; and
a water-containing liquid.

2. The powder composition of claim 1, wherein the poly(vinyl alcohol) polymer is dissolvable in room temperature water.

3. The powder composition of claim 1, wherein the poly(vinyl alcohol) polymer has a weight average molecular weight of 85,000-124,000 g/mol.

4. The powder composition of claim 1, wherein the crosslinker comprises a boron-containing crosslinker.

5. The powder composition of claim 4, wherein the boron-containing crosslinker comprises an aqueous ammonium pentaborate solution.

6. The powder composition of claim 1, wherein the crosslinker comprises a non-boron-containing crosslinker.

7. The powder composition of claim 4, wherein the non-boron-containing crosslinker is selected from the group consisting of water-stable titanates and zirconates.

8. The powder composition of claim 1, further comprising hollow microspheres.

9. The powder composition of claim 1, further comprising at least one additive selected from the group consisting of fillers, colorants, preservatives, glitters, and fragrances.

10. The powder composition of claim 1, further comprising a filler, wherein the filler is cornstarch.

11. The powder composition of claim 1, further comprising:
30-75% by weight of the poly(vinyl alcohol) polymer;
0.1-5% by weight of the crosslinker;
0.1-5% by weight of the calcium silicate and/or the silicon dioxide;
3-10% by weight of the sodium starch glycolate; and
3-12% by weight of the water-containing liquid.

12. A play compound, comprising:
the powder composition according to claim 1; and
a second water-containing liquid.

13. The play compound of claim 12, wherein a ratio of the powder composition to the second water-containing liquid is between 1:2 and 1:6.

14. The play compound of claim 12, wherein the play compounds has a viscosity of between 1000 and 8000 Pa-s.

15. A kit for forming a play compound, the kit comprising the powder composition according to claim 1.

16. A method of forming a play compound, the method comprising:
forming a powder composition comprising:
a poly(vinyl alcohol) polymer,
a crosslinker,
calcium silicate and/or silicon dioxide,
sodium starch glycolate, and
a first water-containing liquid; and
mixing the powder composition and a second water-containing liquid.

17. The method of claim 16, wherein mixing the powder composition and the second water-containing liquid comprises:
shaking or stirring the powder composition and the second water-containing liquid.

18. The method of claim 16, further comprising:
kneading the mixture of the powder composition and the second water-containing liquid.

19. The method of claim 18, further comprising kneading the mixture of the powder composition and the second water-containing liquid to produce a slime consistency.

20. The method of claim 16, wherein forming a powder composition comprises:
preparing a first composition by the mixing a poly(vinyl alcohol) polymer, the crosslinker, calcium silicate and/or silicon dioxide, and sodium starch glycolate; and
adding the first-water containing liquid to the first composition to form the powder composition.
